(19) United States
(12) Patent Application Publication
(10) Pub. No.: US 2022/0255096 A1
(43) Pub. Date: Aug. 11, 2022

(54) DETERMINATION DEVICE AND METHOD FOR CALCULATING A MOISTURE VALUE IN A FUEL CELL SYSTEM

(71) Applicant: AVL List GmbH, Graz (AT)

(72) Inventors: Thomas SCHUBERT, Sankt Marein bei Graz (AT); Stefan TROJER, Leisach (AT)

(73) Assignee: AVL List GmbH, Graz (AT)

(21) Appl. No.: 17/625,797

(22) PCT Filed: Jul. 9, 2020
(86) PCT No.: PCT/AT2020/060265

§ 371 Date: Jan. 10, 2022

(30) Foreign Application Priority Data
Jul. 9, 2019 (AU) A50624/2019

(51) Int. Cl. H01M 8/04492; H01M 8/04119; H01M 8/0438; H01M 8/0432; H01M 8/04828

(52) U.S. Cl. CPC H01M 8/04529; H01M 8/04141; H01M 8/04522; H01M 8/04395; H01M 8/0485; H01M 8/04335; H01M 8/0435; H01M 8/04507; H01M 8/04835; H01M 8/0441

(57) ABSTRACT

The present invention relates to a determination device (1; 1′) for a fuel cell system (2; 2′) having a fuel cell stack (4), comprising a virtual moisture sensor (7) for recording predefined determination values and a computing unit (10) for calculating a moisture value in a cathode inlet region (5) upstream of a cathode section of the fuel cell stack (4) based on the recorded determination values. The invention further relates to a fuel cell system (2; 2′) having such a determination device (1; 1′), methods for determining the moisture value, a computer program product (11) and a storage means having a computer program product (11) stored thereon.

The present invention relates to a determination device for a fuel cell system as well as a method for calculating a moisture value in a cathode inlet region upstream of a cathode section of a fuel cell stack in a fuel cell system.

Various approaches to water management in a fuel cell system are known in the prior art. Among other things, it is important to maintain a moisture value of an electrolyte membrane in the fuel cell stack of the fuel cell system at a desired value and in particular to protect it against drying out. As a rule, various sensors such as moisture sensors for determining corresponding measured values are used for this purpose. The moisture state of the electrolyte membrane can then be concluded on the basis of the measured values. In addition, an imminent moisture state of the electrolyte membrane can be predicted on the basis of the measured values. Furthermore, it is known for the moisture state of the electrolyte membrane to be determined with the aid of impedance spectroscopy. The moisture state of the electrolyte membrane can hereby be concluded on the basis of a measured voltage drop.

A method for determining the moisture in a fuel cell system of this generic type can be found in US 2012/0148927 A1 According to this patent application, it is proposed that the moisture be determined based on a mass equilibrium and/or based on state values for temperatures, pressures and/or flow rates in the fuel cell system.

However, the systems known in the prior art do not yet fully meet the need for a system for determining the moisture in the fuel cell system which is as simple, cost-effective and flexible in use as possible.

The object of the present invention is, accordingly, to create a correspondingly improved determination device as well as an associated method for calculating a moisture value in a fuel cell system. A further object is to provide a system and a method with which an electrolyte membrane can be reliably protected against drying out. The above objects are achieved by the patent claims. In particular, the above objects are achieved by the determination device according to claim 1, the fuel cell system according to claim 5, the method according to claim 9, the method according to claim 13, the method according to claim 14, the computer program product according to claim 15 and the storage means according to claim 16. Further advantages of the invention arise from the dependent claims, the description and the drawings. Naturally, features and details which are described in connection with the determination device also apply in connection with the fuel cell system according to the invention, the method according to the invention, the computer program product according to the invention, the storage means and vice versa, so that with regard to the disclosure, mutual reference is or can always be made to the individual aspects of invention.

According to a first aspect of the present invention, a determination device for a fuel cell system with at least one fuel cell stack is proposed. The determination device has a virtual moisture sensor which comprises a first moisture sensor determination value input for recording a cathode outlet moisture determination value, a second moisture sensor determination value input for recording a stack outlet water mass flow determination value, a third moisture sensor determination value input for recording a stack outlet air mass flow determination value, a fourth moisture sensor determination value input for recording a system inlet water mass flow determination value, a fifth moisture sensor determination value input for recording a system inlet air mass flow determination value, a sixth moisture sensor determination value input for recording a cathode inlet temperature determination value, a seventh moisture sensor determination value input for recording a cathode outlet temperature determination value, an eighth moisture sensor determination value input for recording a cathode inlet pressure determination value and a ninth moisture sensor determination value input for recording a cathode outlet pressure determination value. In addition, the determination device has a computing unit for calculating a moisture value in a cathode inlet region upstream of a cathode section of the fuel cell stack based on the recorded determination values,

With the aid of the virtual moisture sensor and the determination values recorded or taken into consideration according to the invention, the examined moisture value can be calculated relatively accurately. The calculated moisture value can be considered as the relative cathode inlet moisture.

In the context of the present invention it was recognised that, with the aid of the aforementioned determination values, a specific, physical moisture sensor for determining the moisture value can be dispensed with. According to the invention, the already existing sensor technology of the fuel cell system is used to obtain the selected determination values via the virtual moisture sensor in order to calculate the moisture value based on these. The determination device can, accordingly, be understood as a moisture calculation unit.

The virtual moisture sensor does not require any separate, physical components. This means that the virtual moisture sensor can be implemented in a fuel cell system cost-effectively and in a weight- and space-saving manner. In addition, the virtual moisture sensor and the entire determination device can be flexibly integrated into existing fuel cell systems.

The cathode outlet moisture determination value is to be understood to mean a determined value for the relative moisture, more precisely a relative moisture of a fluid, at the cathode outlet. The stack outlet water mass flow determination value is to be understood to mean a determined value of a water mass flow at the stack outlet. The stack outlet air mass flow determination value is to be understood to mean a determined value of an air mass flow at the stack outlet or at the fuel cell stack outlet. The system inlet water mass flow determination value is to be understood to mean a determined value of a water mass flow at the system inlet or at a fuel cell system inlet. The system inlet air mass flow determination value is to be understood to mean a determined value of an air mass flow at the system inlet or at the fuel cell system inlet. The system inlet can be understood to mean a region of the fuel cell system through which ambient air is introduced into the fuel cell system, in particular to the cathode section of the fuel cell stack. The cathode inlet temperature determination value can be understood to mean a determined value of a temperature, in particular a fluid temperature, at the cathode inlet. A cathode outlet temperature determination value can be understood to mean a determined value of a temperature, in particular a fluid temperature, at the cathode outlet.

A cathode inlet pressure determination value can be understood to mean a determined value of a pressure, in particular a fluid pressure, at the cathode inlet. A cathode outlet pressure determination value can be understood to mean a determined value of a pressure, in particular a fluid pressure, at the cathode outlet. The values can be determined with the aid of existing sensors or calculation models and provided at the virtual moisture sensor.

In the context of the invention, the determination device can comprise a virtual sensor system with several virtual sensors, which can include the virtual moisture sensor. The virtual moisture sensor is connected to the computing unit in signal connection to allow calculation of the moisture value and transmission of the recorded determination values to the computing unit. The computing unit can be designed in the form of a computer, a CPU or another suitable processor.

According to a further embodiment of the present invention it is possible that a determination device comprises a virtual system inlet sensor which has a first system inlet sensor determination value input for recording an ambient temperature determination value, a second system inlet sensor determination value input for recording an ambient pressure determination value, a third system inlet sensor determination value input for recording an ambient humidity determination value and a fourth system inlet sensor determination value input for recording a system inlet air mass flow determination value. In this case the computing unit is configured to calculate the system inlet water mass flow determination value based on these recorded determination values, i.e. based on the recorded ambient temperature determination value, the recorded ambient pressure determination value, the recorded ambient humidity determination value and the recorded system inlet air mass flow determination value. This allows a precise system inlet water mass flow determination value to be calculated and the moisture value in the cathode inlet region to be determined accordingly. The ambient temperature determination value is to be understood to mean a determined value of the ambient temperature in the environment of the fuel cell system. The ambient pressure determination value is to be understood to mean a determined value of the ambient pressure in the environment of the fuel cell system. The ambient humidity determination value is to be understood to mean a determined value of the ambient humidity, in particular the relative ambient humidity, in the environment of the fuel cell system, especially in the air within the environment of the fuel cell system. The system inlet air mass flow determination value is to be understood to mean a determined value of an air mass flow at the system inlet or at a fuel cell system inlet as described above.

Furthermore, it is possible that a determination device according to the invention comprises a virtual stack sensor which has a first stack sensor determination value input for recording a cathode inlet water mass flow determination value, a second stack sensor determination value input for recording a cathode inlet temperature determination value, a third stack sensor determination value input for recording a cathode outlet temperature determination value, a fourth stack sensor determination value input for recording a cathode inlet pressure determination value, a fifth stack sensor determination value input for recording a cathode outlet pressure determination value and a sixth stack sensor determination value input for recording a system inlet air mass flow determination value. The computing unit is configured to calculate the cathode outlet moisture determination value based on these determination values, i.e. based on the recorded cathode inlet water mass flow determination value, the cathode inlet temperature determination value, the cathode outlet temperature determination value, the cathode inlet pressure determination value, the cathode outlet pressure determination value and the system inlet air mass flow determination value. This allows a precise cathode outlet moisture determination value to be calculated and the moisture value in the cathode inlet region to be determined accordingly. The cathode inlet water mass flow determination value is to be understood to mean a determined value of a water mass flow at the cathode inlet.

In addition, in a determination device according to of the present invention, it is possible that the computing unit is configured to calculate the cathode inlet water mass flow determination value based on the determination values recorded according to the first aspect. This allows a feedback loop to be created with which an efficient determination of the moisture value is made possible.

It may be the case that, at a time zero, initial values are used for calculation and/or these are assumed as starting values. These can then be saved from a previous shutdown of the system. For operation, this is regulated by the use of delayers, since both gas and water must first flow through the individual paths and cannot pass directly from the system inlet to the cathode input.

According to a further aspect of the present invention, a fuel cell system is provided with a determination device, as described in detail above, for determining a moisture value in the cathode inlet region upstream of the cathode section of the fuel cell stack. Thus, a fuel cell system according to the invention brings the same advantages as have been described in detail with reference to the determination device according to the invention.

It is thereby advantageous if the fuel cell system has a system inlet, wherein an air humidifier is arranged downstream of the system inlet. In particular, the air humidifier is assigned to a virtual moisture sensor. The air humidifier can be designed as an active air humidifier or as a passive air humidifier.

It is favourable if the fuel cell stack is downstream of the air humidifier.

It is also advantageous if the fuel cell system has a return line through which cathode exhaust gas and thus water components can be circulated back from the cathode section of the fuel cell stack into the air humidifier.

It is advantageous if a bypass is provided, wherein the air humidifier can be bypassed via the bypass.

In order to conduct the moist air coming from the cathode section past the air humidifier, the bypass can establish a connection to the return line arranged downstream of the air humidifier and upstream of the fuel cell stack.

The air humidifier is in particular designed as a passive air humidifier. The signal for actuating a corresponding valve is preferably implemented and processed in the virtual sensor. The bypass can be used to control a humidification in that an amount of water passing from the cathode into the air humidifier can be influenced because the bypass conducts moist air coming from the cathode past the humidifier. Furthermore, this means that dry air which would flow from the system inlet into the air humidifier can be mixed with already-humidified air from an aft humidifier output. In both cases this has an influence on the relative moisture at the cathode input.

In addition, a method for calculating a moisture value in a cathode inlet region upstream of a cathode section of a fuel cell stack in a fuel cell system is created. The method according to the invention has the following steps:
recording a cathode outlet moisture determination value, a stack outlet water mass flow determination value, a stack outlet air mass flow determination value, a system inlet water mass flow determination value, a system inlet air mass flow determination value, a cathode inlet temperature determination value, a cathode outlet temperature determination value, a cathode inlet pressure determination value, and a cathode outlet pressure determination value by means of a virtual moisture sensor, and
calculating the moisture value based on the recorded determination values by means of a computing unit.

Thus, such a method also brings with it the advantages described with reference to the determination device.

With this method it is possible that the following steps are carried out by the computing unit in order to calculate the moisture value in the cathode inlet region based on the recorded determination values:
determining difference values between the system inlet water mass flow determination value and the stack outlet water mass flow determination value, the system inlet air mass flow determination value and the stack outlet air mass flow determination value, the cathode inlet temperature determination value and the cathode outlet temperature determination value and/or the cathode inlet pressure determination value and the cathode outlet pressure determination value; and
determining the moisture value in the cathode inlet region based on the cathode outlet moisture determination value and at least one of the difference values.

In a method according to the invention, it is possible that an ambient temperature determination value, an ambient pressure determination value, an ambient humidity determination value and a system inlet air mass flow determination value are recorded by a virtual system inlet sensor, and the system inlet water mass flow determination value based on these determination values is calculated by a computing unit. Furthermore, it is possible that a cathode inlet water mass flow determination value, a cathode inlet temperature determination value, a cathode outlet temperature determination value, a cathode inlet pressure determination value, a cathode outlet pressure determination value and a system inlet air mass flow determination value are recorded by a virtual stack sensor, and the cathode outlet moisture determination value is calculated by a computing unit based on these determination values. In addition, the cathode inlet water mass flow determination value can be calculated by the computing unit based on the determination values described above with regard to the method.

According to a further aspect of the present invention, a method is provided for predicting a moisture state of an electrolyte membrane of the fuel cell stack based on a moisture value in a cathode inlet region upstream of a cathode section of a fuel cell stack in a fuel cell system, wherein the moisture value is calculated according to a method as described above. According to the invention, the prediction of the moisture can be realised simply, cost-effectively, and in a space- and weight-saving manner.

In addition, according to the invention a method for monitoring the moisture in a fuel cell system based on a predicted moisture state of an electrolyte membrane of the fuel cell stack is proposed, wherein the moisture state is predicted by a method as described above. With the aid of such a method, imminent problems such as dehydration of the electrolyte membrane can be detected in good time. Appropriate countermeasures can then be initiated at an early stage. For this purpose, the fuel cell system or the individual functional components of the fuel cell system can be adjusted accordingly, i.e. the fuel cell system can be set to a predefined setpoint state based on the predicted moisture state of the electrolyte membrane. This allows the electrolyte membrane to be protected in good time against dehydration and an undesirable moisture state.

Furthermore, a computer program product is provided which includes commands which, when the computer program product is run on a computer, cause it to carry out a method as described above. In addition, a storage means can be provided with a product computer program stored thereon. The storage means can be provided as a controller with a computer program product according to the invention installed therein. Thus, a computer program product according to the invention and a storage means according to the invention also bring the advantages described above.

The computer program product can be implemented as computer-readable instruction code in any appropriate programming language such as JAVA, C-f-+, C# and/or Python. The computer program product may be stored on a computer-readable storage medium such as a data disk, a removable drive, a volatile or non-volatile memory, or in a built-in memory/processor. The instruction code can program a computer or other programmable device to perform the desired functions. Furthermore, the computer program product may be provided in a network such as the Internet, from which it can be downloaded by a user as required. The computer program product can be realised both by means of a computer program, i.e. as software, as well as by means of one or more special electronic circuits, i.e. as hardware, or in any hybrid form, i.e. by means of software components and hardware components.

Further measures to improve the invention are explained in the following description of various exemplary embodiments of the invention, which are represented schematically in the figures. All features and/or advantages resulting from the claims, the description or the figures, including constructive details and spatial arrangements, may be essential to the invention both in themselves and in the various combinations.

In each case schematically:

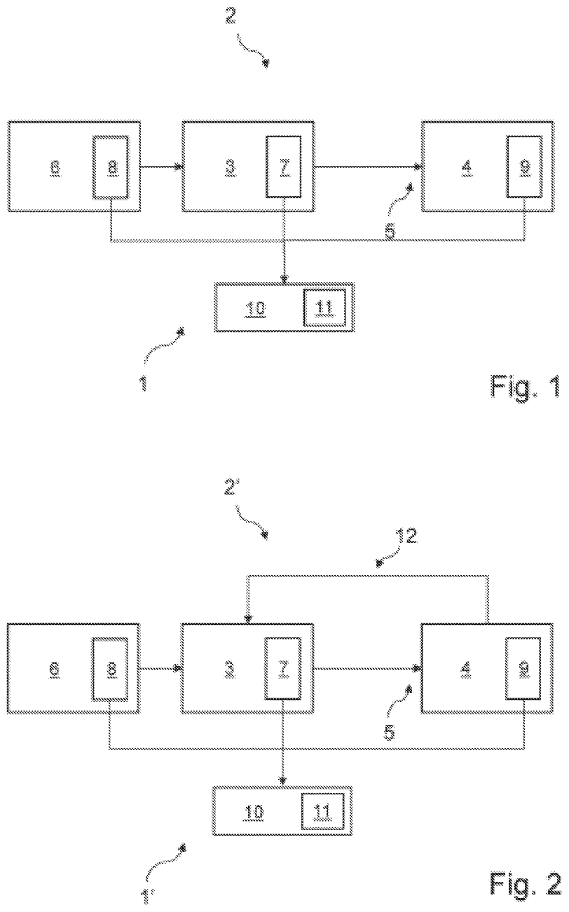

FIG. 1 shows a fuel cell system with a determination device according to a first embodiment of the present invention installed therein,

FIG. 2 shows a fuel cell system with a determination device according to a second embodiment of the present invention installed therein,

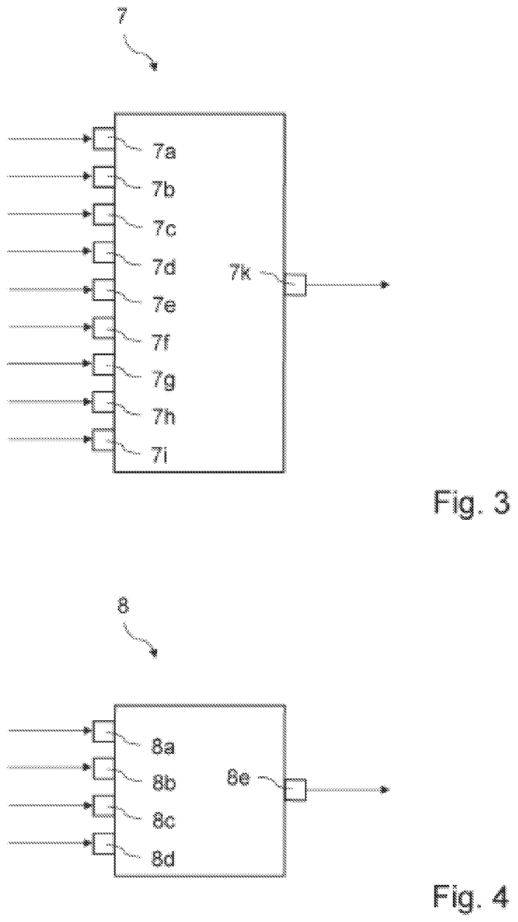

FIG. 3 shows a virtual moisture sensor according to a preferred embodiment of the present invention,

FIG. 4 shows a virtual system inlet sensor according to a preferred embodiment of the present invention,

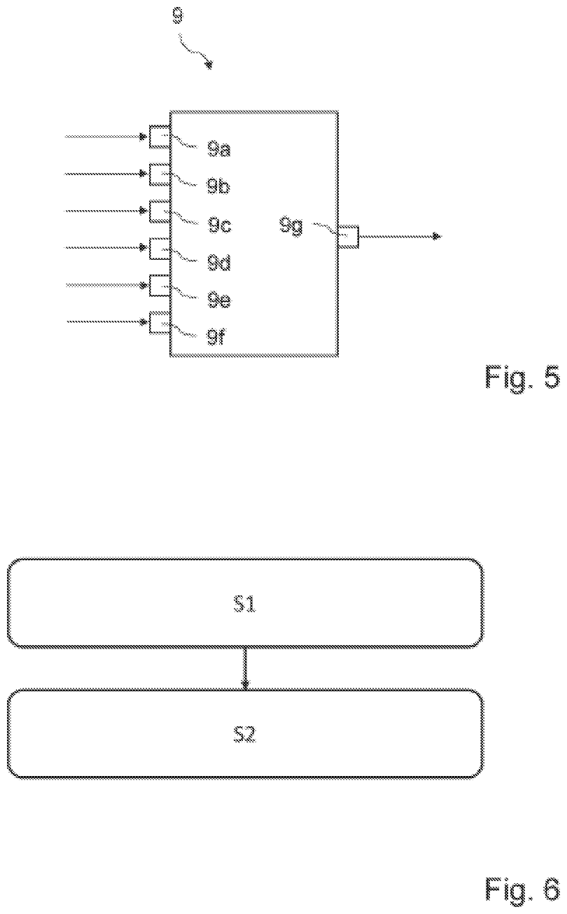

FIG. 5 shows a virtual stack sensor according to a preferred embodiment of the present invention, and

FIG. 6 shows a flowchart serving to explain a method according to a first embodiment of the present invention.

Elements with the same function and mode of action are each provided with the same reference signs in FIGS. 1 to 6.

FIG. 1 shows, schematically, a fuel cell system 2 with a determination device 1 according to a first embodiment installed therein. The fuel cell system 2 has a system inlet 6, an air humidifier 3 arranged downstream of the system inlet 6 and a fuel cell stack 4 arranged downstream of the air humidifier 3. The fuel cell stack 4 has an anode section and a cathode section, wherein an electrolyte membrane (not shown) is arranged between the anode section and the cathode section. According to the exemplary embodiment shown in FIG. 1, a virtual system inlet sensor 8 is assigned to the system inlet 6. A virtual moisture sensor 7 is assigned to the air humidifier 3. A virtual stack sensor 9 is assigned to the fuel cell stack 4. The system inlet sensor 8, the moisture sensor 7 and the stack sensor 9 are in each case in signal connection with a computing unit 10 of the fuel cell system 2. A computer program product 11 is installed in the computing unit 10.

FIG. 2 shows a fuel cell system 2′ with a determination device 1′ according to a second embodiment. The second embodiment substantially corresponds to the first embodiment. The distinguishing feature is a return line 12 through which cathode exhaust gas and thus water components can be circulated back from the cathode section of the fuel cell stack 4 into the air humidifier 3.

FIG. 1 and FIG. 2 in each case show a system overview, the subsystems of which are then explained in detail with reference to FIGS. 3 to 5.

The virtual moisture sensor 7 shown in FIG. 3 has a first moisture sensor determination value input 7a for recording a cathode outlet moisture determination value, a second moisture sensor determination value input 7b for recording a stack outlet water mass flow determination value, a third moisture sensor determination value input 7c for recording a stack outlet air mass flow determination value, a fourth moisture sensor determination value input 7d for recording a system inlet water mass flow determination value, a fifth moisture sensor determination value input 7e for recording a system inlet air mass flow determination value, a sixth moisture sensor determination value input 7f for recording a cathode inlet temperature determination value, a seventh moisture sensor determination value input 7g for recording a cathode outlet temperature determination value, an eighth moisture sensor determination value input 7h for recording a cathode inlet pressure determination value and a ninth moisture sensor determination value input 7i for recording a cathode outlet pressure determination value.

The virtual moisture sensor 7 also has a signal output 7k for transmitting the recorded determination values to the computing unit 10. Based on the determination values recorded by the moisture sensor 7, the computing unit 10 can calculate a moisture value in a cathode inlet region 5 upstream of the cathode section of the fuel cell stack 4.

Difference values can be determined mathematically, for example by forming a difference between absolute amounts of a value pair of recorded determination values which are measured, in relation to the same parameter, at the cathode inlet and at the cathode outlet respectively. The moisture value in the cathode inlet region can also be determined mathematically in that the computing unit 10 places the cathode outlet moisture determination value in relation to a factor. The factor is based on a function whose function variables comprise at least one of the recorded determination values, in particular a difference value, which is determined from the determination values recorded in relation to the same parameter, and may optionally include an absolute temperature value.

The virtual system inlet sensor 8 shown in FIG. 4 has a first system inlet sensor determination value input 8a for recording an ambient temperature determination value, a second system inlet sensor determination value input 8b for recording an ambient pressure determination value, a third system inlet sensor determination value input 8c for recording an ambient humidity determination value and a fourth system inlet sensor determination value input 8d for recording a system inlet air mass flow determination value. The virtual system inlet sensor 8 also has a signal output 8e for transmitting the recorded determination values to the computing unit 10. Based on the determination values recorded by the system inlet sensor 8, the computing unit 10 can calculate the system inlet water mass flow determination value.

The virtual stack sensor 9 shown in FIG. 5 shows a first stack sensor determination value input 9a for recording a cathode inlet water mass flow determination value, a second stack sensor determination value input 9b for recording a cathode inlet temperature determination value, a third stack sensor determination value input 9c for recording a cathode outlet temperature determination value, a fourth stack sensor determination value input 9d for recording a cathode inlet pressure determination value, a fifth stack sensor determination value input 9e for recording a cathode outlet pressure determination value and a sixth stack sensor determination value input 9f for recording a system inlet air mass flow determination value. The virtual stack sensor 9 also has a signal output 9g for transmitting the recorded determination values to the computing unit 10. Based on the determination values recorded by the stack sensor 9, the computing unit 10 can calculate the cathode outlet moisture determination value and the cathode inlet water mass flow determination value.

A method for calculating the moisture value in the cathode inlet region 5 will be explained with reference to FIG. 6. For this purpose, in a first step S1, the cathode outlet moisture determination value, the stack outlet water mass flow determination value, the stack outlet air mass flow determination value, the system inlet water mass flow determination value, the system inlet air mass flow determination value, the cathode inlet temperature determination value, the cathode outlet temperature determination value, the cathode inlet pressure determination value and the cathode outlet pressure determination value are recorded or detected by means of the virtual moisture sensor 7. In a second step S2, the moisture value and the cathode inlet water mass flow determination value are then calculated by the computing unit 10 based on these recorded or considered determination values.

In addition to the embodiments depicted, the invention allows for further design principles. That is to say, the invention should not be considered to be limited to the exemplary embodiments explained with reference to the figures.

For example, within the framework of the method, the ambient temperature determination value, the ambient pressure determination value, the ambient humidity determination value and the system inlet air mass flow determination value can be recorded by the virtual system inlet sensor 8. The system inlet water mass flow determination value can then be calculated by the computing unit 10 based on these determination values.

In addition, the cathode inlet water mass flow determination value, the cathode inlet temperature determination value, the cathode outlet temperature determination value, the cathode inlet pressure determination value, the cathode outlet pressure determination value and the system inlet air mass flow determination value can be recorded by the virtual stack sensor 9. The cathode outlet moisture determination value can then be calculated by the computing unit 10 based on these determination values.

In other words, the water mass fraction of the airflow in the cathode path can be calculated based on signals indicating the air mass flow at the system inlet 6, as well as the pressures, the temperatures and the relative moisture values at the fuel cell stack 4. The relative humidity at the cathode outlet and the water mass flow at the system inlet 6 are used as supplementary input signals for the virtual moisture sensor. The moisture transfer can then be determined dynamically using parameters of the air humidifier 3 such as a membrane thickness, a membrane surface area and/or a membrane density of the air humidifier 3 and the relative moisture on the dry and the moist sides of the air humidifier 3. The value of the relative moisture at the cathode input can be calculated relatively accurately with the aid of the explicitly selected temperature values, pressure values and mass flow values.

The total mass flow of water from the fuel cell system 2, 2′ is calculated in the fuel cell system 2, 2′ from the inflowing water, the generated water and the part of the water which diffuses to the anode. In addition to the generated water mass, a power requirement for the system can also be used as an additional signal input.

In a humidifier model, the method can also easily be adapted to a system with external humidification by means of water injection. In particular, the humidifier model is structured in such a way that it is not limited to a passive humidification, but is also applicable to systems with active humidification.

In addition, the method can also be further developed in order to predict a moisture state of an electrolyte membrane of the fuel cell stack 4 based on the moisture value in the cathode inlet region 5 upstream of the cathode section of the fuel cell stack 4 in the fuel cell system 2, wherein the moisture value is calculated as described above. In addition, it is possible that a method for monitoring the moisture in a fuel cell system 2 based on a predicted moisture state in an electrolyte membrane of the fuel cell stack 4 is carried out, wherein the moisture state is predicted using a method as described above.

The calculation of the moisture value according to the invention can also be carried out depending on the current power requirement of the fuel cell system, i.e. if a lot of power is required, a correspondingly increased air intake can be assumed.

The amount of water produced in the fuel cell stack 4 also increases depending on this power demand or electricity demand, which is reflected in the amount of water which leaves the cathode and flows into the humidifier. This results in better humidification in the humidifier and thus, again, in a higher humidity at the cathode input.

### LIST OF REFERENCE SIGNS

1.1′ determination device
2.2′ fuel cell system
3 air humidifier
4 fuel cell stack
5 cathode inlet region
6 system inlet
7 virtual moisture sensor
7a-7i moisture sensor determination value inputs
8 virtual system inlet sensor
8a-8d system inlet sensor determination value inputs
9 virtual stack sensor
9a-9g stack sensor determination value input
10 computing unit
11 computer program product
12 return line

1. Determination device (1; 1′) for a fuel cell system (2; 2′) with a fuel cell stack (4), having a virtual moisture sensor (7) comprising
a first moisture sensor determination value input (7a) for recording a cathode outlet moisture determination value,
a second moisture sensor determination value input (7b) for recording a stack outlet water mass flow determination value,
a third moisture sensor determination value input (7c) for recording a stack outlet air mass flow determination value,
a fourth moisture sensor determination value input (7d) for recording a system inlet water mass flow determination value,
a fifth moisture sensor determination value input (7e) for recording a system inlet air mass flow determination value,
a sixth moisture sensor determination value input (7f) for recording a cathode inlet temperature determination value,
a seventh moisture sensor determination value input (7g) for recording a cathode outlet temperature determination value,
an eighth moisture sensor determination value input (7h) for recording a cathode inlet pressure determination value, and
a ninth moisture sensor determination value input (7i) for recording a cathode outlet pressure determination value,
and a computing unit (10) for calculating a moisture value in a cathode inlet region (5) upstream of a cathode section of the fuel cell stack (4) based on the recorded determination values.

2. Determination device (1; 1′) according to claim 1,
characterised by
a virtual system inlet sensor (8) having
a first system inlet sensor determination value input (8a) for recording an ambient temperature determination value,
a second system inlet sensor determination value input (8b) for recording an ambient pressure determination value,
a third system inlet sensor determination value input (8c) for recording an ambient humidity determination value, and
a fourth system inlet sensor determination value input (8d) for recording a system inlet air mass flow determination value
wherein the computing unit (10) is configured to calculate the system inlet water mass flow determination value based on the determination values.

3. Determination device (1; 1′) according to claim 1,
characterised by
a virtual stack sensor (9) having
a first stack sensor determination value input (9a) for recording a cathode inlet water mass flow determination value,
a second stack sensor determination value input (9b) for recording a cathode inlet temperature determination value,
a third stack sensor determination value input (9c) for recording a cathode outlet temperature determination value,
a fourth stack sensor determination value input (9d) for recording a cathode inlet pressure determination value,
a fifth stack sensor determination value input (9e) for recording a cathode outlet pressure determination value, and
a sixth stack sensor determination value input (9f) for recording a system inlet air mass flow determination value,
wherein the computing unit (10) is configured to calculate the cathode outlet moisture determination value based on the determination values.

4. Determination device (1; 1′) according to claim 3,
wherein
the computing unit (10) is configured to calculate the cathode inlet water mass flow determination value based on the determination values.

5. Fuel cell system (2; 2′) with a determination device (1; 1′) according to claim 1 for determining a moisture value in the cathode inlet region (5) upstream of the cathode section of the fuel cell stack (4).

6. Fuel cell system (2, 2′) according to claim 5, wherein the fuel cell system (2, 2′) has a system inlet (6), wherein an air humidifier (3) is arranged downstream of the system inlet (6).

7. Fuel cell system (2, 2′) according to claim 6, wherein the fuel cell stack (4) is downstream of the air humidifier (3).

8. Fuel cell system (2, 2′) according to claim 6, wherein the fuel cell system (2, 2′) has a return line (12), through which cathode exhaust gas and thus water components can be circulated back from the cathode section of the fuel cell stack (4) into the air humidifier (3).

9. Fuel cell system (2, 2′) according to claim 6, wherein a bypass is provided, wherein the air humidifier (3) can be bypassed via the bypass.

10. Fuel cell system (2, 2′) according to claim 8, wherein the bypass establishes a connection to the return line (12) arranged downstream of the air humidifier (3) and upstream of the fuel cell stack (4).

11. Method for calculating a moisture value in a cathode inlet region (5) upstream of a cathode section of a fuel cell stack (4) in a fuel cell system (2; 2′), comprising the steps:
recording a cathode outlet moisture determination value, a stack outlet water mass flow determination value, a stack outlet air mass flow determination value, a system inlet water mass flow determination value, a system inlet air mass flow determination value, a cathode inlet temperature determination value, a cathode outlet temperature determination value, a cathode inlet pressure determination value, and a cathode outlet pressure determination value by means of a virtual moisture sensor (7), and
calculating the moisture value based on the recorded determination values by means of a computing unit (10).

12. Method according to claim 11,
wherein
in order to calculate the moisture value in the cathode inlet region (5) based on the recorded determination values, the computing unit (10) carries out the following steps:
determining difference values between the system inlet water mass flow determination value and the stack outlet water mass flow determination value, the system inlet air mass flow determination value and the stack outlet air mass flow determination value, the cathode inlet temperature determination value and the cathode outlet temperature determination value and/or the cathode inlet pressure determination value and the cathode outlet pressure determination value; and
determining the moisture value in the cathode inlet region (5) based on the cathode outlet moisture determination value and at least one of the difference values.

13. Method according to claim 11,
wherein
an ambient temperature determination value, an ambient pressure determination value, an ambient humidity determination value and a system inlet air mass flow determination value are recorded by a virtual system inlet sensor (8), and the system inlet water mass flow determination value is calculated by a computing unit (10) based on the recorded determination values.

14. Method according to claim 11,
wherein
a cathode inlet water mass flow determination value, a cathode inlet temperature determination value, a cathode outlet temperature determination value, a cathode inlet pressure determination value, a cathode outlet pressure determination value and a system inlet air mass flow determination value are recorded by a virtual stack sensor (9), and the cathode outlet moisture determination value is calculated by a computing unit (10) based on the recorded determination values.

15. Method according to claim 11,
wherein
the cathode inlet water mass flow determination value is calculated by the computing unit (10) based on the determination values.

16. Method predicting a moisture state of an electrolyte membrane of the fuel cell stack (4) based on a moisture value in a cathode inlet region (5) upstream of a cathode section of a fuel cell stack (4) in a fuel cell system (2; 2′), wherein the moisture value is calculated according to a method according to claim 11.

17. Method for monitoring the moisture in a fuel cell system (2; 2′) based on a predicted moisture state of an electrolyte membrane of the fuel cell stack (4), wherein the moisture state is predicted using a method according to claim 16.

18. Computer program product (11) comprising commands that cause the computer program product (11) to carry out the method according to claim 11.

19. Storage means with a computer program product (11) according to claim 18 stored thereon.
